(19) United States
(12) Patent Application Publication
(10) Pub. No.: US 2023/0173919 A1
(43) Pub. Date: Jun. 8, 2023

(54) METHOD AND SYSTEM FOR ASSISTING CIRCUIT DRIVING

(71) Applicants: HYUNDAI MOTOR COMPANY, Seoul (KR); KIA CORPORATION, Seoul (KR)

(72) Inventor: Minhan KIM, Anyang-si (KR)

(73) Assignees: Hyundai Motor Company, Seoul (KR); KIA CORPORATION, Seoul (KR)

(21) Appl. No.: 17/991,191

(22) Filed: Nov. 21, 2022

(30) Foreign Application Priority Data
Dec. 6, 2021 (KR) 10-2021-0172874

(51) Int. Cl. B60K 35/00

(52) U.S. Cl. CPC B60K 35/00; B60K 2370/162; B60K 2370/176; B60K 2370/1529; B60K 2370/592; B60K 2370/171

(57) ABSTRACT

Provided is a method of providing a driving instruction for assisting circuit driving, the method including: constructing a database based on driving data obtained as a result of driving of a plurality of vehicles on a circuit; generating a plurality of driving instructions based on the database; providing the user with one of the plurality of driving instructions based on a selection of a user.

### CROSS-REFERENCE TO RELATED APPLICATION

This application is based on and claims priority under 35 U.S.C. §119 to Korean Patent Application No. 10-2021-0172874, filed on Dec. 6, 2021 in the Korean Intellectual Property Office, the disclosure of which is incorporated herein by reference.

### TECHNICAL FIELD

The present disclosure relates to a method of assisting circuit driving assistance method and a system for assisting circuit driving, and more specifically, to a method and system for providing a driver with a driving instruction for assisting circuit driving.

### BACKGROUND

People enjoy various hobbies to satisfy individual needs thereof. As an example of various hobbies, there is an automobile race in which drivers have a speed completion in vehicles.

However, when running an automobile race on a general road, traffic laws need to be complied with, and the risk of collision with a general vehicle is high with the competitive spirit of the driver.

A circuit is a place in which drivers run a race in vehicles, and in addition referred to as a racing track, and an operation of driving a vehicle on a circuit is referred to circuit driving. Drivers may show off their driving skills by competing with others through circuit driving.

However, circuit driving is considered a hobby having a high degree of risk and entry barriers for the general public.

### SUMMARY

Therefore, it is an object of the disclosure to provide a method and system for providing users with driving instructions for circuit driving.

The technical objectives of the disclosure are not limited to the above, and other objectives may become apparent to those of ordinary skill in the art based on the following descriptions.

According to an aspect of the disclosure, there is provided a method of assisting circuit driving, which is a method of providing a driving instruction for assisting circuit driving, the method including: constructing a database based on driving data obtained as a result of driving of a plurality of vehicles on a circuit; generating a plurality of driving instructions based on the database; and providing a user with one of the plurality of driving instructions based on a selection of the user.

The plurality of driving instructions may include at least one of: a recommended speed for each section of the circuit, a recommended braking point of the circuit, a recommended acceleration point of the circuit, a recommended shift section of the circuit, a recommended steering amount for each section of the circuit, an APEX of the circuit, or a recommended trail line of the circuit.

The providing of the user with the at least one of the plurality of driving instructions may include: transmitting a first driving instruction selected by the user to a first vehicle of the user; and displaying, by the first vehicle, the first driving instruction on at least one of a head-up display, an audio-video-navigation (AVN) device, or a cluster.

The displaying, by the first vehicle, of the first driving instruction includes displaying visual feedback for following the first driving instruction based on driving data of the first vehicle.

The displaying, by the first vehicle, of the first driving instruction may include controlling the head-up display such that a recommended trail line included in the first driving instruction is mapped to a road of the circuit.

The displaying, by the first vehicle, of the first driving instruction may include: generating a virtual vehicle image based on the first driving instruction; and controlling the head-up display such that the virtual vehicle image is mapped to a road of the circuit.

The displaying, by the first vehicle, of the first driving instruction may include: displaying, on the AVN device, a road image of the circuit obtained from a front camera; and controlling the AVN device such that a recommended trail line included in the first driving instruction is mapped to the road image of the circuit.

The displaying, by the first vehicle, of the first driving instruction may include: displaying, on the AVN device, a road image of the circuit obtained from a front camera; generating a virtual vehicle image based on the first driving instruction; and controlling the AVN device such that the virtual vehicle image is mapped to the road image of the circuit.

The displaying, by the first vehicle, of the first driving instruction may include controlling the cluster to display visual feedback for guiding adjustment of a vehicle speed to follow the first drive instruction.

The displaying, by the first vehicle, of the first driving instruction may include controlling the cluster to display visual feedback for guiding manipulation of a shift gear to follow the first drive instruction.

The plurality of driving instructions include a first driving instruction and a second driving instruction, and the method may further include: outputting visual feedback indicating that the first driving instruction is a driving instruction for a beginner; and outputting visual feedback indicating that the second driving instruction is a driving instruction for an intermediate or advanced user.

The generating of the plurality of driving instructions based on the database may include: generating a first driving instruction based on first driving database obtained from a first vehicle; and generating a second driving instruction based on second driving database obtained from a second vehicle.

The generating of the plurality of driving instructions based on the database may include: obtaining first driving data for minimizing a driving record by inputting the driving data for constructing the database into a trained neural network model; and generating a first driving instruction based on the first driving data.

The providing of the user with one of the plurality of driving instructions may include providing the user with a driving image of a virtual vehicle driving on the circuit according to the driving instruction selected by the user.

According to another aspect of the disclosure, there is provided a system for assisting circuit driving, which is a system for providing a driving instruction for assisting circuit driving, the system including: a server configured to store a database constructed based on driving data obtained as a result of driving of a plurality of vehicles on a circuit, and generate a plurality of driving instructions based on the database; and a first vehicle configured to, based on receiving a user input to select a first driving instruction among the plurality of driving instructions, transmit a request signal for requesting the server to transmit the first driving instruction, wherein the server is configured to, based on receiving the request signal from the first vehicle, transmit the first driving instruction to the first vehicle, and the first vehicle is configured to, based on receiving the first driving instruction, display the first driving instruction on at least one of a head-up display, an audio-video-navigation (AVN) device, or a cluster.

The first vehicle may be configured to display visual feedback for following the first driving instruction based on driving data of the first vehicle.

The first vehicle may be configured to control the head-up display such that a recommended trail line included in the first driving instruction is mapped to a road of the circuit.

The first vehicle may be configured to: generate a virtual vehicle image based on the first driving instruction; and control the head-up display such that the virtual vehicle image is mapped to a road of the circuit.

The first vehicle may be configured to: display, on the AVN device, a road image of the circuit obtained from a front camera; and control the AVN device such that a recommended trail line included in the first driving instruction is mapped to the road image of the circuit.

The first vehicle may be configured to: display, on the AVN device, a road image of the circuit obtained from a front camera; generate a virtual vehicle image based on the first driving instruction; and control the AVN device such that the virtual vehicle image is mapped to the road image of the circuit.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram for describing an example of a circuit;

FIG. 2 illustrates a system for assisting circuit driving according to an embodiment;

FIG. 3 is a block diagram for describing a configuration of a system for assisting circuit driving according to an embodiment;

FIG. 4 is a flowchart showing an example of a method of assisting circuit driving according to an embodiment;

FIG. 5 illustrates an example of driving data according to an embodiment;

FIGS. 6 and 7 illustrate examples of driving instructions according to an embodiment;

FIG. 8 is a flowchart showing an example of a method of providing a driving instruction based on a selection of a user;

FIG. 9 illustrates an example of a user interface for allowing a user to select a driving instruction;

FIG. 10 is a flowchart showing an example of a method of providing a driving instruction to a user by a vehicle according to an embodiment;

FIG. 11 illustrates an example of a vehicle providing a driving instruction through a head-up display according to an embodiment;

FIG. 12 illustrates an example of a vehicle providing driving data through a head-up display according to an embodiment;

FIG. 13 illustrates an example of a vehicle providing a driving instruction through an AVN device according to an embodiment;

FIG. 14 illustrates another example of a vehicle providing a driving instruction through an AVN device according to an embodiment;

FIG. 15 illustrates an example of a vehicle providing a driving instruction through a cluster according to an embodiment; and

FIG. 16 illustrates another example of a vehicle providing a driving instruction through a cluster according to an embodiment.

### DETAILED DESCRIPTION

Advantages and features of embodiments, and methods of achieving the same will be clearly understood with reference to the accompanying drawings and the following detailed embodiments. However, the present inventive concept is not limited to embodiments described herein, but may be implemented in various different forms. Embodiments are provided in order to explain the present inventive concept for those skilled in the art. The scope of the present inventive concept is defined by the appended claims.

The terms used herein will be briefly described and embodiments will be described in detail.

Although the terms used herein are selected from among general terms that are currently and widely used in consideration of functions in embodiments, these may be changed according to intentions or customs of those skilled in the art or the advent of new technology. In addition, in a specific case, some terms may be arbitrary selected by applicants. In this case, meanings thereof will be described in a corresponding description of embodiments. Therefore, the meanings of terms used herein should be interpreted based on substantial meanings of the terms and content of this entire specification, rather than simply the terms themselves.

Throughout this specification, when a certain part “includes” a certain component, it means that another component may be further included not excluding another component unless otherwise defined. Moreover, terms described in the specification such as “part,” “module,” and “unit,” refer to a unit of processing at least one function or operation, and may be implemented by software, a hardware component such as a field-programmable gate array (FPGA) or an application-specific integrated circuit (ASIC), or a combination of software and hardware. However, the terms “part,” “module,” “unit,” and the like are not limited to software or hardware. “Part,” “module,” “unit,” and the like may be configured in a recording medium that may be addressed or may be configured to be reproduced on at least one processor. Therefore, examples of the terms “part,” “module,” “unit,” and the like include software components, object-oriented software components, components such as class components and task components, processes, functions, properties, procedures, subroutines, segments in program codes, drivers, firmware, microcode, circuits, data, databases, data structures, tables, arrays, and variables. The components and the modules may be provided into smaller number of components and modules such that the respective component and modules may be merged in respect to the functionality.

Reference numerals used for method steps are just used for convenience of explanation, but not to limit an order of the steps. Thus, unless the context clearly dictates otherwise, the written order may be practiced otherwise.

Hereinafter, embodiments of a system 1 and method of assisting circuit driving will be described in detail with reference to the accompanying drawings. In addition, parts irrelevant to description are omitted in the drawings in order to clearly explain embodiments. In addition, parts irrelevant to description are omitted in the drawings in order to clearly explain embodiments. In the accompanying drawings, parts that are identical or equivalent to each other will be assisted the same reference numerals, and in the following description of the embodiments, details of redundant descriptions thereof will be omitted.

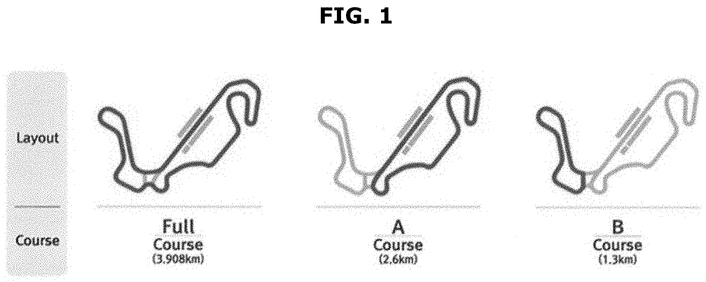

FIG. 1 is a diagram for describing an example of a circuit.

Referring to FIG. 1, a circuit may refer to a track on which a driver runs an automobile race, and even when a drive drives the same circuit, the circuit may have different driving routes according to a plurality of courses.

The circuit in the present disclosure may include not only a track having a starting point that is the same as an ending point but in addition a track having a starting point that is different from an ending point.

In addition, the circuit map information in the present disclosure may include not only information about the circuit but in addition information about each of a plurality of courses in which the circuit is driven.

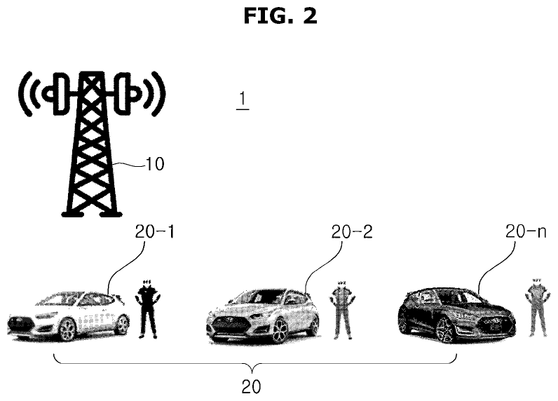

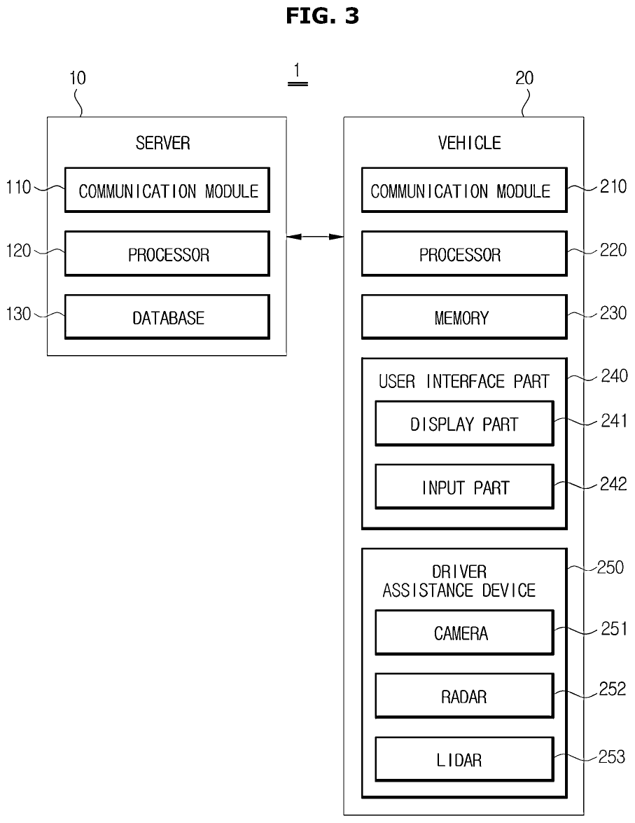

FIG. 2 illustrates a system for assisting circuit driving according to an embodiment. FIG. 3 is a block diagram for describing a configuration of a system for assisting circuit driving according to an embodiment.

Referring to FIGS. 2 and 3, a system 1 for assisting circuit driving according to the embodiment may include a server 10 and a plurality of vehicles 20 communicating with the server 10.

The server 10 may store a database 130 constructed based on source data including driving data for the circuit, generate a driving instruction for the circuit based on the database 130, and provide the plurality of vehicles 20 with the driving instruction.

The source data may include driving data obtained from a manufacturer and/or an operator of the system 1 for assisting circuit driving.

The driving data may include information about sensor values obtained through a plurality of sensors and/or information obtained by a driver assistance device 250 while an arbitrary vehicle 20 is driving on an arbitrary circuit, and may include information about the arbitrary vehicle 20 and/or information about the arbitrary circuit. In addition, the driving data may further include weather information.

The server 10 may further include at least one memory 230 for storing the database 130 constructed based on the source data, and may utilize the database 130 based on a big data analysis algorithm.

For example, the server 10 may classify driving data constructing the database 130 according to the type of a circuit and/or the type of a vehicle 20, and calculate a driving instruction for a specific circuit based on the driving data.

To this end, the server 10 may include at least one processor 120 for processing the database 130.

The processor 120 may calculate a plurality of driving instructions based on the processing of the driving data that constructs the database 130.

The processor 120 according to an exemplary embodiment of the present disclosure may be a hardware device implemented by various electronic circuits (e.g., computer, microprocessor, CPU, ASIC, circuitry, logic circuits, etc.). The processor 120 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

According to the embodiment, the processor 120 may include a hardware structure specialized for processing an artificial intelligence model. Artificial intelligence models may be generated through machine learning. Such learning may be performed, for example, by the vehicle 20, or may be performed through the server 10. Learning algorithms may include, for example, supervised learning, unsupervised learning, semi-supervised learning, or reinforcement learning, but the disclosure is not limited to the above example. An artificial intelligence model may include a plurality of artificial neural network layers. An artificial neural network may include a deep neural network (DNN), a convolutional neural network (CNN), a recurrent neural network (RNN), a restricted boltzmann machine (RBMs), a deep belief network (DBN), a bidirectional recurrent deep neural network (BRDNN), a deep Q-networks, or a combination of two or more of the above, but the disclosure is not limited to the above example. The artificial intelligence model may include, additionally, or alternatively, a software structure in addition to the hardware structure.

The processor 120 may use the driving data as training data to execute a learning algorithm for outputting an optimal driving instruction, and may use a trained artificial intelligence model to output an optimal driving instruction from driving data.

That is, the processor 120 may use driving data as input data to output a driving instruction as output data.

An example, the processor 120 may use driving data obtained from the plurality of vehicles 20 as input data to output an optimal driving instruction.

As another example, the processor 120 may use driving data obtained from a single vehicle 20 as input data to output a driving instruction corresponding to a driving route of the single vehicle 20.

In addition, the processor 120 may execute an algorithm for executing the above-described operations and/or operations to be described below. For example, the processor 120 may control the communication module 110 to transmit driving data and/or driving instructions to the vehicle 20.

The database 130 may include a plurality of driving instructions output from the processor 120.

Details of the driving data and driving instruction will be described below.

The server 10 may transmit driving data constructing the database 130 and a plurality of driving instructions to the plurality of vehicles 20.

To this end, the server 10 may include the communication module 110 for communicating with the plurality of vehicles 20.

The communication module 110 is a wireless communication module (e.g., a cellular communication module 110, a short-range wireless communication module, or a global navigation satellite system (GNSS) communication module or a wired communication module (e.g., a local area network (LAN) communication module, or a power line communication module). The communication module 110 may communicate with the vehicle 20 of outside through a first network (e.g., a short-range communication network, such as Bluetooth, wireless fidelity (WiFi) direct or infrared data association (IrDA)) or a second network (e.g., a long range communication network, such as a legacy cellular network, a 5G network (e.g., OTA), a next-generation communication network, the Internet, and a computer network (e.g., LAN or WAN)).

The vehicle 20 may receive driving data and/or driving instructions from the server 10.

In addition, the vehicle 20 may transmit, to the server 10, driving data obtained while driving on the circuit. Accordingly, the server 10 may update the database 130 using the driving data received from the vehicle 20, and may generate a plurality of driving instructions based on the updated database 130.

According to various embodiments, the plurality of vehicles 20 may share driving data with each other through V2V communication.

To this end, the vehicle 20 may include a communication module 210 for communicating with another vehicle and/or the server 10, and the communication module 210 of the vehicle 20 may transmit and receive data to and from the communication module 110 of the server 10. The communication module 210 of the vehicle 20 may represent the same configuration as that of the communication module 110 of the server 10, and the same descriptions will be omitted.

The vehicle 20 includes a memory 230 that memorizes/stores programs, instructions, and data for controlling various components (e.g., a user interface part 240) of the vehicle 20, and a processor 220 that generates a control signal for controlling the operation of the vehicle 20 based on the programs, the instructions, and the data memorized/stored in the memory 230.

For example, the memory 230 may store an instruction for processing the driving instruction received from the server 10 into a form that may be displayed on a display part 241, and the processor 220 may process the driving instruction received from the server 10 into a form that may be displayed on the display part 241 based on the stored instruction, and control the display part 241 to display the driving instruction.

In addition, the processor 220 may include an image signal processor and/or a digital signal processor that process data (e.g., image data, radar data, and Lidar data) obtained from the driver assistance device 250. The processor 220 and the memory 230 may be implemented as separate chips or as a single chip.

In addition, the processor 220 may process data (e.g., speed data, steering angle data, and pedal input data) obtained from various sensors of the vehicle 20.

The processor 220 may include a logic circuit and an arithmetic circuit, process data according to programs/instructions provided from the memory 230, and generate a control signal according to a result of processing. The memory 230 may temporarily memorize data received from various sensors of the vehicle 20 and/or the driver assistance device 250, and temporarily memorize a result of data processed by the processor 220. The memory 230 may include not only volatile memories, such as S-RAM and D-RAM, but in addition nonvolatile memories, such as a flash memory, a read-only memory (ROM), an erasable programmable read only memory (EPROM), etc.

The processor 220 may communicate with various electronic components of the vehicle 20 through a vehicle communication network. For example, the processor 220 may exchange data with electronic components through Ethernet, Media Oriented Systems Transport (MOST), Flexray, Controller Area Network (CAN), Local Interconnect Network (LIN), etc.

For example, the processor 220 may obtain image information, radar information, and/or Lidar information obtained from the driver assistance device 250 through a vehicle communication network, and obtain information about sensor values obtained from various vehicle sensors of the vehicle 20.

Although not shown in the drawings, the vehicle 20 may include a plurality of vehicle sensors for obtaining driving data of the vehicle 20. The plurality of vehicle sensors will be described below.

The vehicle 20 may include a user interface part 240 for communicating with a user (a driver).

The user interface part 240 includes a display part 241 for displaying various types of information related to circuit driving (e.g., driving data and/or driving instructions) and an input part 242 for receiving various user inputs related to circuit driving.

The display part 241 may include at least one display. The at least one display may be a Light Emitting Diode (LED) panel, an Organic Light Emitting Diode (OLED) panel, a Liquid Crystal Display (LCD) panel, and/or an indicator. In addition, the display part 241 may include a touch screen.

For example, the display part 241 may include a navigation device (an AVN device; 241-2), a head-up display 241-1, and/or a cluster 241-3.

The display part 241 may output driving data and/or driving instructions processed by the processor 220.

The input part 242 may include buttons, dials, and/or touchpads provided at various positions within the vehicle 20.

For example, the input part 242 may include a push button, a touch button, a touch pad, a touch screen, a dial, a stick-type operation device, and/or a track ball. When the input part 242 is implemented as a touch screen, the input part 242 may be provided integrally with the display part 241.

The input part 242 may receive a user input for receiving driving data and/or driving instruction from the server 10 and/or a user input for displaying driving data and/or driving instruction.

For example, the processor 220 may, in response to a user input for receiving a driving instruction being received through the input part 242, control the communication module 210 to transmit a request signal for requesting the driving instruction from the server 10.

Although not shown in the drawings, the user interface part 240 may further include at least one speaker for outputting sound. For example, the AVN device 241-2 of the vehicle 20 may output a sound signal based on a control signal of the processor 220.

The vehicle 20 may include the driver assistance device 250 for assisting the driver.

The driver assistance device 250 includes at least one camera 251 for obtaining an image of a surrounding of the vehicle 20, at least one radar 252 for detecting an object of a surrounding of the vehicle 20, and/or a Lidar 253 for obtaining point cloud data of a surrounding of the vehicle 20.

Although not shown in the drawings, the driver assistance device 250 may further include a global positioning system (GPS) module for obtaining position information of the vehicle 20. The GPS module may obtain GPS information of the vehicle 20. The GPS information may include position data of the vehicle 20.

The camera 251 may include a front camera having a field of view facing in a forward direction of the vehicle 20, a rear camera having a field of view facing in a rear direction of the vehicle 20, and a side camera having a field of view facing in a side direction of the vehicle 20.

According to various embodiments, the camera 251 may include a black box camera for recording a driving situation of the vehicle 20.

The camera 251 may be electrically connected to the processor 220. For example, the camera 251 may be connected to the processor 220 through a vehicle communication network, a hard wire, or a printed circuit board (PCB).

The processor 220 may, based on the image obtained from the camera 251 being processed, recognize an object around the vehicle 20.

In an embodiment, the processor 220 may, based on images obtained from the plurality of cameras 251 being processed, obtain a bird's eye view of the vehicle 20.

Specifically, the processor 220 may, based on image data being processed, obtain environmental information of a circuit road around the vehicle 20.

The radar 252 may include a front radar having a field of sensing that faces in a forward direction of the vehicle 20, a rear radar having a field of sensing that faces in a rear direction of the vehicle 20, and a side radar having a field of sensing that faces in a side direction of the vehicle 20.

The radar 252 may be electrically connected to the processor 220. For example, the radar 252 may be connected to the processor 220 through a vehicle communication network, a hard wire, or a PCB.

The processor 220 may, based on detection data obtained from the radar 252 being processed, recognize an object around the vehicle 20.

The Lidar 253 may obtain a relative position, relative speed, etc. of a moving object (e.g., another vehicle, a pedestrian, a cyclist, etc.) around the vehicle 20. In addition, the Lidar 253 may obtain the shape and position of a nearby fixed object (e.g., a track line, a sign, a traffic light, a bump, etc.). The Lidar 253 may be installed in the vehicle 20 to have an external view of the vehicle 20, and may obtain point cloud data for the external view of the vehicle 20.

The processor 220 may process the point cloud data obtained from the Lidar 253 to recognize the structure of the circuit around the vehicle 20.

Hereinafter, an example of implementing a method of assisting circuit driving using each configuration of the system 1 for assisting circuit driving described above will be described.

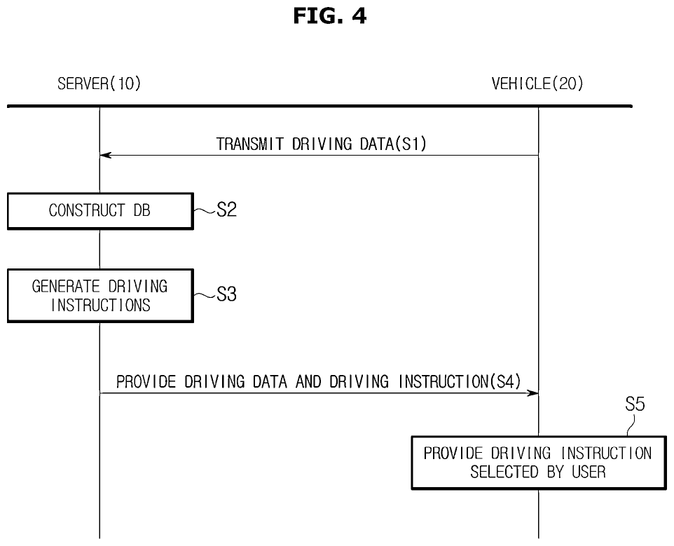

FIG. 4 is a flowchart showing an example of a method of assisting circuit driving according to an embodiment.

Referring to FIG. 4, a plurality of vehicles 20 may transmit, to the server 10, driving data obtained by driving on a circuit (S1).

A user may drive on a circuit using the vehicle 20, and the vehicle 20 may obtain driving data while driving on the circuit.

According to various embodiments, the vehicle 20 may, based on a preset condition being satisfied, transmit the driving data obtained while driving on the circuit to the server 10.

As an example, based on a user executing an application for providing the circuit driving assistance system 1 through the user interface part 240 and then driving on a circuit, the vehicle 20 may transmit driving data obtained from the vehicle 20 to the server 10.

The server 10 may, based on the driving data received from the vehicle 20, construct the database 130 (S2). That is, the server 10 may utilize the driving data received from the vehicle 20 as a part of big data.

The server 10 may generate a plurality of driving instructions based on the constructed database 130 (S3).

As an example, the server 10 may input the driving data constructing the database 130 into the trained neural network model to obtain first driving data for minimizing the driving record, and based on the first driving data, generate a first driving instruction.

As an example, the server 10 may input the driving data constructing the database 130 into the trained neural network model to obtain first driving data for minimizing the use of the brake, and based on the first driving data, generate a first driving instruction.

As an example, the server 10 may input the driving data constructing the database 130 into the trained neural network model to obtain first driving data for minimizing the use of the acceleration pedal, and based on the first driving data, generate a first driving instruction.

As an example, the server 10 may input the driving data constructing the database 130 into the trained neural network model to obtain first driving data for minimizing the steering amount, and based on the first driving data, generate a first driving instruction.

As an example, the server 10 may generate a first driving instruction based on first driving data that is included in the driving data constructing the database 130, which is received from the first vehicle 20.

According to various embodiments, the server 10 may generate the first driving instruction by generating commands for providing various types of feedback that allow the vehicle 20 to follow the first driving data.

The plurality of driving instructions may be classified according to various criteria and stored in the server 10.

For example, the plurality of driving instructions may be classified according to various criteria, such as a driving difficulty, a vehicle type, a driver's identity, and the like.

The server 10 may provide the vehicle 20 with driving data and/or driving instructions (S4).

For example, the vehicle 20 may, based on a user input to request driving data and/or a driving instruction being received through the user interface part 240, transmit a request signal to the server 10, and the server 10 may, based on receiving the request signal, transmit the corresponding driving data and/or driving instruction to the vehicle 20.

The vehicle 20 may store the driving data and/or the driving instruction received from the server 10 and may provide the driving instruction selected by the user (S5).

Specifically, the vehicle 20 may receive a user input for selecting one of a plurality of driving instructions through the user interface part 240, and control the user interface part 240 to provide the driving instruction selected by the user.

For example, the vehicle 20 may display the driving instruction on at least one of the head-up display 241-1, the AVN device 241-2, or the cluster 241-3.

As another example, the vehicle 20 may output the driving instruction in the form of a sound through the AVN device 241-2.

According to the disclosure, a user may be provided with a lowered entry barrier to a circuit driving.

In addition, according to the present disclosure, a user may be provided with a customized driving instruction by selecting a desired driving instruction.

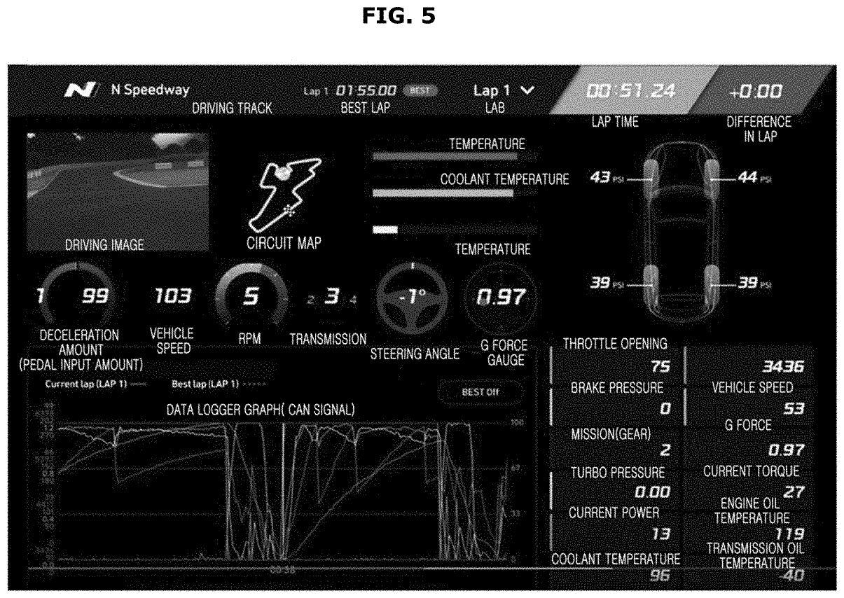

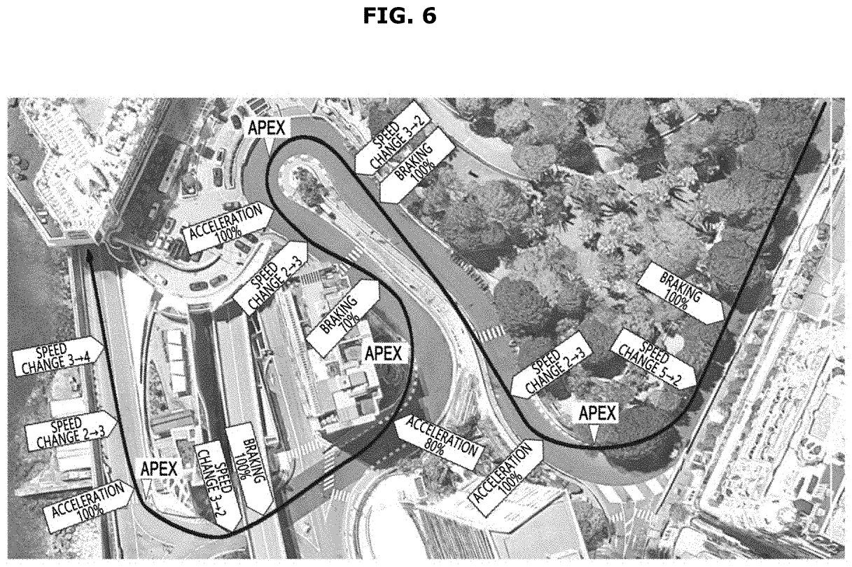

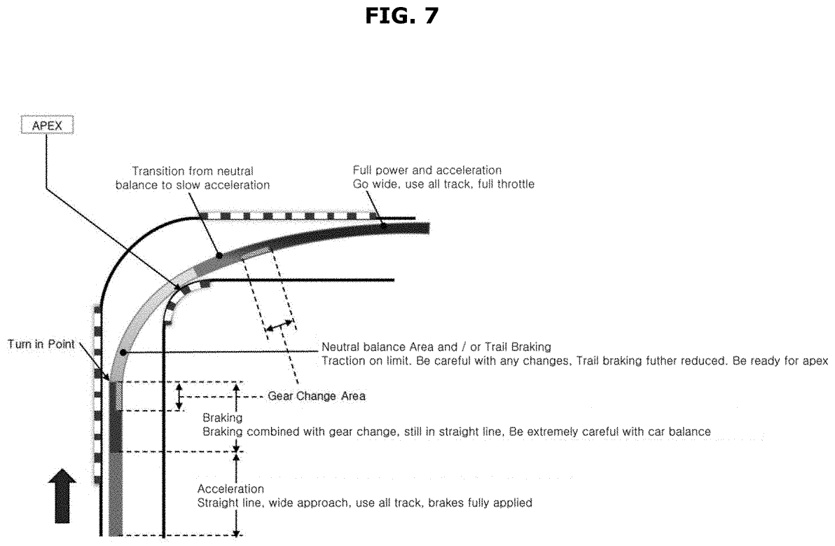

FIG. 5 illustrates an example of driving data according to an embodiment. FIGS. 6 and 7 illustrate examples of driving instructions according to an embodiment.

Referring to FIG. 5, driving data may include various types of data obtained while the vehicle 20 is driving on a circuit.

For example, driving data includes information about a circuit, driving image information, position information of the vehicle 20 in the circuit, driving record information of the vehicle 20, engine oil temperature information, coolant temperature information, transmission oil temperature information, pedal input information, vehicle speed information, revolution per minute (RPM) information, transmission gear information, steering angle information, gravitational acceleration information, tire pressure information, throttle opening amount information, brake pressure information, turbo pressure information, and/or output information.

Such information may be transmitted to the processor 220 through a vehicle communication network (e.g., CAN communication), the processor 220 may process each piece of information, and the memory 230 may be store data processed by the processor 220.

As an example, the driving data may include information about a plurality of sensor values that change according to the position of the vehicle 20 in the circuit.

Furthermore, the driving data of the vehicle 20 may further include profile information of the user and information about the vehicle 20.

As an example, the user may execute an application for assisting circuit driving through the user interface part 240, make an access with an account of the user to input vehicle information and/or user information linked to the account, and the server 10 may store various pieces of information in linkage with the user's account.

The server 10 may, in response to first driving data being received from a first vehicle 20-1, store the first driving data by including information about the first vehicle 20-1 and/or first user information in the first driving data.

In addition, the driving data may be data for generating a driving instruction for a circuit, and may include all types of data for generating a driving instruction.

The driving data may include vehicle specification information, circuit information, external environment information, vehicle operation information, vehicle inflow information, and additional information.

The vehicle specification information may include characteristic information of the vehicle 20, such as the body type, length/width/height/wheelbase/front/rear tread, weight, driving method, output, maximum torque, tire air pressure of the vehicle 20, etc.

The circuit information may include characteristic information of a circuit, such as a circuit course, cornering curvature, APEX, and inclination.

The external environment information may include external environment information, such as weather information and wind speed information when the driving data is generated.

The vehicle operation information may include information about acceleration/deceleration timing, acceleration/deceleration point, pedal input amount (tip in/out), shift and timing, vehicle speed, and steering amount of the vehicle 20 in the circuit.

The vehicle inflow information may include electronic control suspension (ECS) status, traction control, roll/yaw/pitch sensing data, slip/over/understeer, G-force gauge data, booster pressure, RPM, torque/output operation, various liquid/gas inflow/outflow amount/temperature, fuel consumption amount, and driving image information.

The additional information may include tuning information of the vehicle 20. The tuning information may refer to information about a tuning product attached to the vehicle 20, and the user may directly input tuning information through the user interface part 240.

Referring to FIGS. 6 and 7, the server 10 may generate driving instructions for each circuit based on the database 130. Hereinafter, for the sake of convenience of description, it is assumed that the server 10 generates a driving instruction for a specific circuit.

The driving instruction may be provided in a wide range of driving instructions depending on the use and purpose, and may be displayed together with content provided by an infotainment system (e.g., the user interface part 240) of the vehicle 20.

The driving instruction is related to control of the vehicle 20, and may be provided to the user in a manner matched with GPS-based position information of the vehicle 20.

For example, the driving instruction may include at least one of the recommended speed for each section of the circuit, the recommended braking point of the circuit, the recommended acceleration point of the circuit, the recommended speed change section of the circuit, the recommended steering amount for each section of the circuit, the APEX of the circuit, or the recommendation trail line of the circuit.

As will be described below, users belonging to one group may be provided with additional driving instructions.

For example, the driving instruction provided to users belonging to one group may include information about a lap time difference between competing vehicles and/or position information of the competing vehicles and/or speed information of the competing vehicles.

The information about the recommended speed for each section of the circuit may include information about a recommended speed that may be optimally driven in a corresponding section considering the driving characteristics and the limit speed of the vehicle 20.

The information about the recommended braking point of the circuit may include information about a section requiring braking before entering a corner and the degree of braking force.

The information about the recommended acceleration point of the circuit may include information about a recommended acceleration amount and a recommended tip-in amount considering optimization in entering the next corner after leaving a corner.

The information about the recommended speed change section of the circuit may include information about a recommended speed change section for efficient output operation before and after entering a corner.

The information about the recommended steering amount for each section of the circuit may include information about a recommended steering amount considering corner curvatures and terrain characteristics.

The information about the APEX of the circuit may include apex information considering driving characteristics and limits of the vehicle 20, the corner shape and the characteristics of the circuit, or the vehicle speed of the vehicle 20.

The information about the recommended trail line of the circuit may include information about a record line for the vehicle 20 to drive on the circuit on an optimal path.

Circuit driving is characterized by driving while drawing a trail line (a record line) for optimal driving and utilizing the entire road width of the circuit road. In particular, as shown in FIG. 6, there is no lane in most circuits. In the circuit driving, the record is greatly affected by the trail line being drawn during the drive. Accordingly, based on the clear position of the vehicle on the road width of the circuit road and the current driving position, the relationship between a line drawn so far and a line to be drawn in the future is important. In addition, since most trail lines are based on action plans for the APEX and the corner, it is in addition very important to display action plans of the APEX and the corner.

The server 10 may map the driving of the vehicle 20 onto the circuit map based on the driving data constructing the database 130, and generate the driving instruction through simulation of the driving of the vehicle 20.

According to various embodiments, the driving instruction may be processed by the server 10 into a form (e.g., graphic/speech) that may be mapped to and usable in the infotainment system (e.g., the user interface part 240) of the vehicle 20, and transmitted to the vehicle 20.

According to another embodiment, the driving instruction may be transmitted to the vehicle 20, in which the driving instruction may be processed by the vehicle 20 into a form (e.g., graphic/speech) that may be mapped to and usable in the infotainment system (e.g., the user interface part 240) of the vehicle 20, and transmitted to the user.

For example, referring to FIG. 7, the vehicle 20 may display the trail line in different colors or display an action tip for each section such that the user recognizes the characteristics of each section, and may output a speech corresponding to each section based on the position of the vehicle 20 such that the user recognizes the action tip in each section.

Various embodiments in which the vehicle 20 provides driving instructions to a user will be described below.

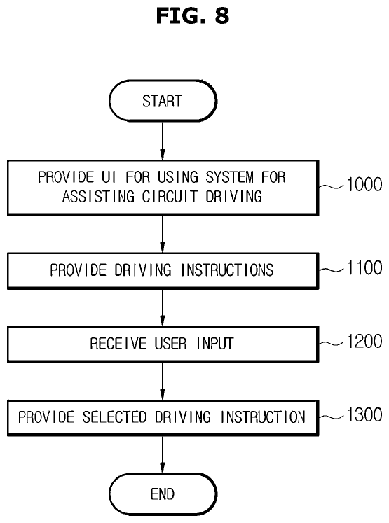

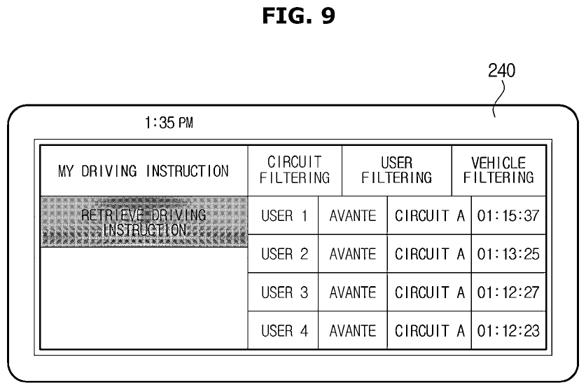

FIG. 8 is a flowchart showing an example of a method of providing a driving instruction based on a selection of a user. FIG. 9 illustrates an example of a user interface for allowing a user to select a driving instruction.

Hereinafter, for the sake of convenience of description, one of the plurality of vehicles 20 is assumed as a first vehicle 20-1, and the user of the first vehicle 20-1 is referred to as a first user. Another one of the plurality of vehicles 20 is assumed as a second vehicle 20-2, and the user of the second vehicle 20-2 is referred to as a second user. Another one of the plurality of vehicles 20 is assumed as a third vehicle 20-n, and the user of the third vehicle 20-n is referred to as a third user.

In the disclosure, the first vehicle 20-1 and the first user may represent the same object. For example, when the first vehicle 20-1 and the second vehicle 20-2 belong to one group, it may be understood that the first user and the second user belong to one group.

Referring to FIGS. 8 and 9, the vehicle 20 according to an embodiment may provide a user interface for using the system 1 for assisting circuit driving (1000).

For example, the first vehicle 20-1 may control the user interface part 240 to display a user interface (hereinafter, referred to as a ‘first user interface’) for selecting a driving instruction.

The first user interface may include a menu for selecting a driving instruction generated based on driving data thereof and a menu for retrieving a driving instruction generated based on the database 130 of the server 10.

When the user selects the menu for selecting the driving instruction generated based on the driving data, visual feedback for selecting one of a plurality of instructions generated based on driving data obtained through driving on the circuit by the first user with the first vehicle 20-1 may be provided.

For example, the plurality of driving instructions generated based on the driving data obtained through driving on the circuit by the first user with the first vehicle 20 may be divided and provided according to a driving date and time, a circuit type, a lap time, and the like.

When the first user selects the menu for retrieving driving instructions generated based on the database 130 of the server 10, visual feedback for selecting one of the plurality of driving instructions generated based on the database 130 of the server 10 may be provided.

According to various embodiments, the first vehicle 20-1 may control the user interface part 240 to classify and display driving instructions according to various criteria.

For example, the first vehicle 20-1 may classify driving instructions based on the driver's identity.

As an example, the first vehicle 20-1 may control the user interface part 240 to provide visual feedback for selecting a first driving instruction generated based on first driving data obtained from the first vehicle 20-1, a second driving instruction generated based on second driving data obtained from the second vehicle 20-2, and/or a third driving instruction generated based on third driving data obtained from the third vehicle 20-n.

As another example, the first vehicle 20-1 may control the user interface part 240 to provide visual feedback for selecting a first driving instruction for a beginner, a second driving instruction for an intermediate user, and/or a third driving instruction for an advanced user.

As another example, the first vehicle 20-1 may control the user interface part 240 to provide visual feedback for selecting a first driving instruction to minimize the driving record, a second driving instruction to minimize use of the brake, and/or a third driving instruction to minimize use of the accelerator pedal.

The first user may filter the driving instructions according to various criteria to retrieve a driving instruction desired by the first user.

For example, the first user may filter the driving instructions according to various categories, such as a circuit type, a driver's identity, and/or a vehicle type, to retrieve a driving instruction desired by the first user.

When the first user sets the vehicle type to Avante and the circuit type to Circuit A, the first user may be provided with a user interface for selecting a driving instruction generated based on driving data obtained through driving on Circuit A by a plurality of users using Avante.

As described above, the server 10 and/or the first vehicle 20-1 may provide the first user with a plurality of driving instructions (1100).

The first user may select one of the plurality of driving instructions through the user interface part 240, and the first vehicle 20-1 may receive a user input to select the one of the plurality of driving instructions through the user interface part 240. (1200).

The first vehicle 20-1 may, based on receiving the user input for selecting the one of the plurality of driving instructions, transmit a request signal for requesting the selected driving instruction to the server 10, and the server 10 may provide, based on receiving the request signal, provide the driving instruction to the first vehicle 20-1.

The first vehicle 20-1 may provide the selected driving instruction to the first user such that the first user may recognize the driving instruction while driving on the circuit (1300).

According to the present disclosure, a user may easily select a desired driving instruction among a plurality of driving instructions classified according to various criteria.

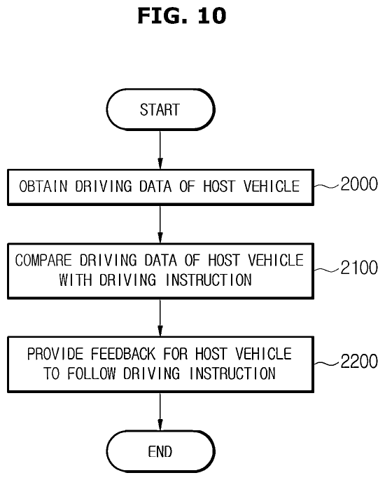

FIG. 10 is a flowchart showing an example of a method of providing a driving instruction to a user by a vehicle according to an embodiment.

Referring to FIG. 10, the first vehicle 20-1 may obtain driving data of the first vehicle 20-1 (2000).

For example, the first vehicle 20-1 may obtain a plurality of sensor values from the plurality of vehicle sensors, and accurately identify the position of the first vehicle 20-1 in the circuit from the driver assistance device 250.

Specifically, the first vehicle 20-1 may obtain information about the position of the first vehicle 20-1 in the circuit and information about the position (e.g., the distances to both side boundaries of the road) of the first vehicle 20-1 in the road of the circuit from the driver assistance device 250, and may obtain engine oil temperature information, coolant temperature information, transmission oil temperature information, pedal input information, vehicle speed information, revolution per minute (RPM) information, transmission gear information, steering angle information, gravitational acceleration information, tire pressure information, throttle opening degree information, brake pressure information, turbo pressure information, and/or output information of the first vehicle 20-1 from the plurality of sensors.

The first vehicle 20-1 may compare the first driving data of the first vehicle 20-1 with the driving instruction (2100).

For example, the first vehicle 20-1 may compare the first driving data of the first vehicle 20-1 with driving data corresponding to the driving instruction.

The first vehicle 20-1 may provide feedback for the first vehicle 20-1 to follow the driving instruction based on the first driving data of the first vehicle 20-1 (2200).

As an example, when the speed of the first vehicle 20-1 is lower than a recommended speed at the current location of the first vehicle 20-1, the first vehicle 20-1 may provide feedback for increasing the speed.

As another example, when the on-road position at the current location of the first vehicle 20-1 deviates to the left of a recommended position, the first vehicle 20-1 may provide feedback for moving the on-road position of the first vehicle 20-1 to the right.

The first vehicle 20-1 may control the user interface part 240 to provide feedback for the first vehicle 20-1 to follow the driving instruction based on the driving data of the first vehicle 20-1.

For example, the first vehicle 20-1 may provide feedback for following a driving instruction through the head-up display 241-1, the AVN device 241-2, and/or the cluster 241-3.

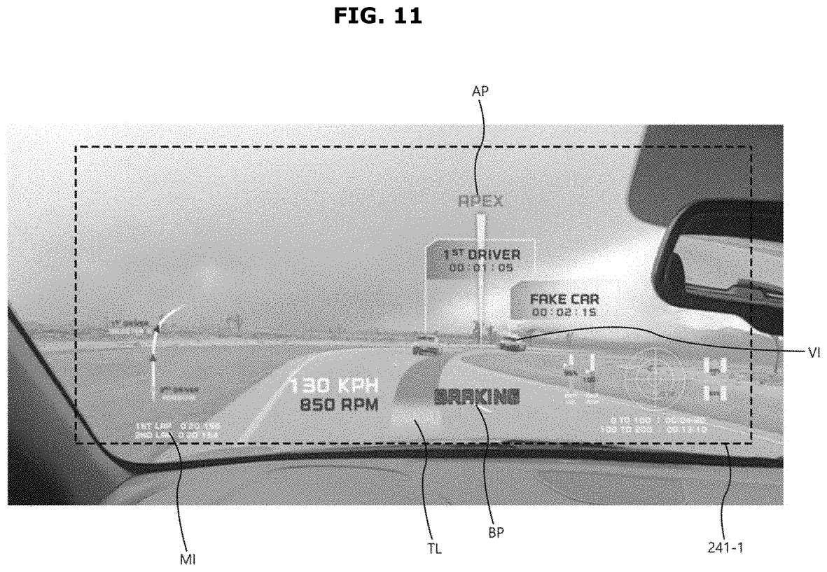

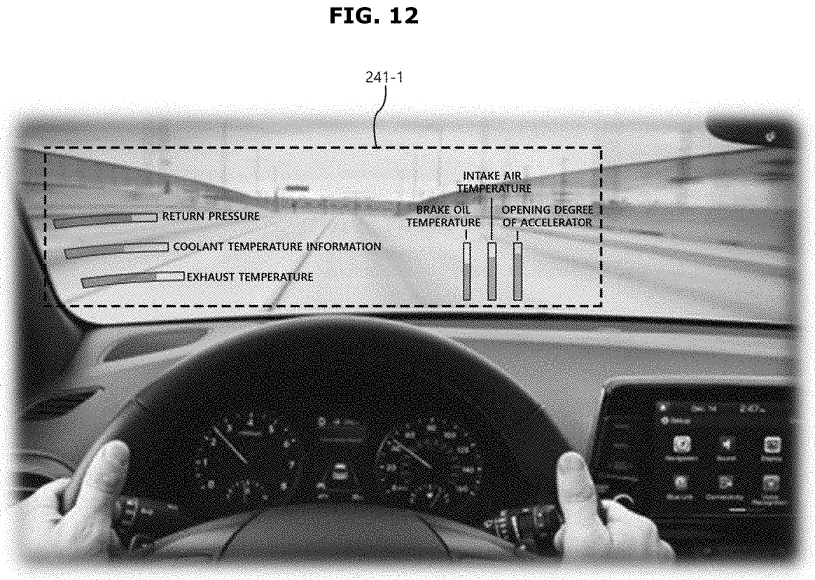

FIG. 11 illustrates an example of a vehicle providing a driving instruction through a head-up display according to an embodiment. FIG. 12 illustrates an example of a vehicle providing driving data through a head-up display according to an embodiment.

Referring to FIG. 11, the vehicle 20 may display various types of driving instructions through the head-up display 241-1.

According to various embodiments, the vehicle 20 may control the head-up display 241-1 such that the driving instruction is mapped to and displayed on the road of the circuit.

For example, the vehicle 20 may identify the position of the vehicle 20 on the road within the circuit through the driver assistance device 250, and accordingly, control output of visual feedback such that the visual feedback output to the head-up display 241-1 is mapped to and displayed on the road.

For example, the vehicle 20 may control the head-up display 241-1 such that a recommended trail line TL included in the driving instruction is mapped to and displayed on the road of the circuit.

Each section of the recommended trail line TL may be set to have a different color according to a recommended speed for each section.

That is, the vehicle 20 may adjust the color of at least one section of the recommended trail line TL based on the recommended speed for each section of the circuit.

For example, a section in which deceleration of the vehicle 20 is required among sections of the recommended trail line TL may be displayed in red, and a section in which acceleration is required among sections of the recommended trail line TL may be displayed in green. In addition, a section in which speed maintenance is required among sections of the recommended trail line TL may be displayed in yellow.

According to the present disclosure, it is easy for the user to follow the recommended trail line TL while looking forward.

As another example, the vehicle 20 may control the head-up display 241-1 such that a recommended braking point BP and/or a recommended acceleration point included in the driving instruction is mapped to and displayed on the road of the circuit. Accordingly, the recommended braking point BP and/or the recommended acceleration point may be displayed to be mapped to a specific point on the road in the circuit through the head-up display 241-1.

According to various embodiments, the vehicle 20 may generate a virtual vehicle image VI based on a driving instruction. In this case, the virtual vehicle may refer to a virtual object that travels on a circuit according to a driving instruction.

The vehicle 20 may control the head-up display 241-1 such that the virtual vehicle image VI is mapped to and displayed on the road of the circuit. The virtual vehicle image VI may be generated in various shapes/colors/sizes according to user settings.

In an embodiment, the vehicle 20 may control the head-up display 241-1 to display visual feedback for identifying the virtual vehicle. The visual feedback for identifying the virtual vehicle may include rank information of the virtual vehicle and/or lap time information of the virtual vehicle.

According to the present disclosure, the driver of the vehicle 20 may enjoy competition with the virtual vehicle, and may improve the driving skill by imitating the driving of the virtual vehicle.

In an embodiment, the vehicle 20 may control the head-up display 241-1 to display APEX information (AP) in the circuit. Specifically, the vehicle 20 may control the head-up display 241-1 such that the position corresponding to the AP is mapped to and displayed on the road of the circuit.

According to various embodiments, a plurality of vehicles 20 may belong to one group. As an example, a first user may open a group for circuit driving through the user interface part 240, and a second user may join the group opened by the first user through the user interface part 240.

As another example, a first user may invite a second user to a group through the user interface part 240, and the second user may accept the invitation of the first user through the user interface part 240 so that the first user and the second user may belong to one group.

The server 10 may, based on the first user and the second user being belonging to one group, classify the first user and the second user into one group.

A plurality of vehicles 20 belonging to one group may share driving data thereof in real time. For example, a plurality of vehicles 20 belonging to one group may share driving data thereof in real time through V2V communication, or may share driving data thereof in real time through the server 10.

As an example, a first vehicle 20-1 may receive position information of a second vehicle 20-2 in real time, and the second vehicle 20-2 may receive position information of the first vehicle 20-1 in real time.

As another example, the first vehicle 20-1 may receive information (e.g., a plate number, a vehicle model, etc.) about the second vehicle 20-2, and the second vehicle 20-2 may receive information about the first vehicle 20-1.

In an embodiment, the vehicle 20 may control the head-up display 241-1 to display visual feedback for identifying other vehicles belonging to the same group.

The visual feedback for identifying other vehicles belonging to the same group may include information (e.g., identities of drivers) of other vehicles, ranking information of other vehicles, and/or lap time information of other vehicles.

In addition, the vehicle 20 may control the head-up display 241-1 to display map information MI of the circuit. The map information MI of the circuit may include information about the position of a host vehicle on the circuit, the positions of other vehicles belonging to the same group, and/or the position of a virtual vehicle.

Referring to FIGS. 11 and 12, according to various embodiments, the vehicle 20 may control the head-up display 241-1 to display driving data in real time.

For example, the vehicle 20 may control the head-up display 241-1 to display vehicle speed information, engine RPM information, engine oil temperature information, coolant temperature information, transmission oil temperature information, pedal input information, vehicle speed information, RPM information, transmission gear information, steering angle information, gravitational acceleration information, tire pressure information, throttle opening degree information, brake pressure information, turbo pressure information, and/or output information.

According to various embodiments, the vehicle 20 may display the driving data in the form of a gauge bar such that the user may intuitively recognize the driving data.

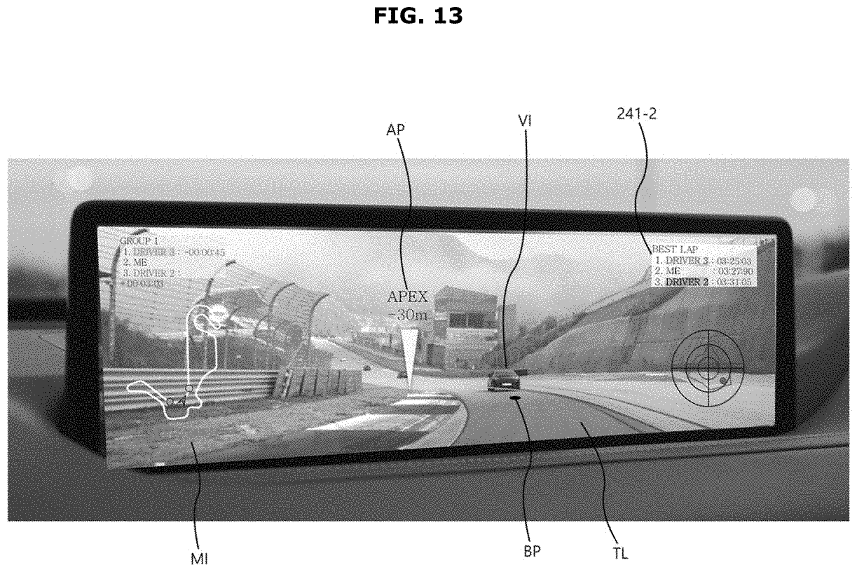

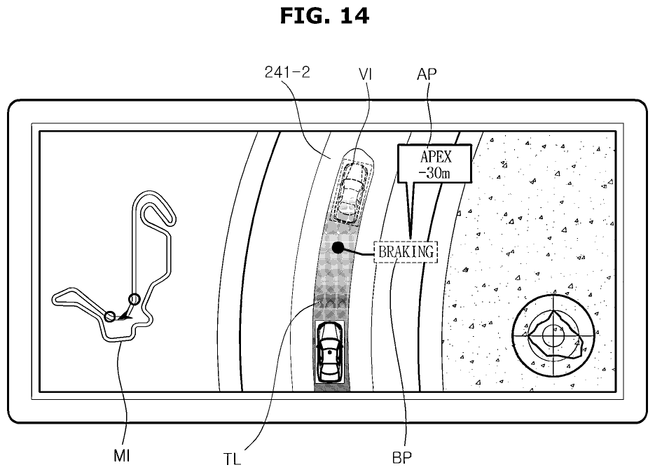

FIG. 13 illustrates an example of a vehicle providing a driving instruction through an AVN device according to an embodiment. FIG. 14 illustrates another example of a vehicle providing a driving instruction through an AVN device according to an embodiment.

Referring to FIG. 13, the vehicle 20 may control the AVN device 241-2 to display a road image of the circuit obtained from the camera 251 (e.g., a front camera).

According to various embodiments, the vehicle 20 may control the AVN device 241-2 such that the driving instruction is mapped to and displayed on the road image of the circuit.

For example, the vehicle 20 may obtain a road image of the circuit through the camera 251 (e.g., a front camera) of the driver assistance device 250 and control output of visual feedback such that the driving instruction is mapped to and displayed on the road image of the circuit.

As an example, the vehicle 20 may control the AVN device 241-2 such that a recommended trail line TL included in the driving instruction is mapped to and displayed on the road image of the circuit.

As another example, the vehicle 20 may control the AVN device 241-2 such that a recommended braking point BP and/or a recommended acceleration point included in the driving instruction are mapped to and displayed on the road image of the circuit. Accordingly, the recommended braking point BP and/or the recommended acceleration point may be displayed to be mapped to specific points of the road image of the circuit through the AVN device 241-2.

According to various embodiments, the vehicle 20 may generate a virtual vehicle image VI based on a driving instruction. In this case, the virtual vehicle may refer to a virtual object that travels on a circuit according to a driving instruction.

The vehicle 20 may control the AVN device 241-2 such that the virtual vehicle image VI is mapped to and displayed on the road image of the circuit. The virtual vehicle image VI may be generated in various shapes/colors/sizes according to user settings.

In an embodiment, the vehicle 20 may control the AVN device 241-2 to display visual feedback for identifying the virtual vehicle. The visual feedback for identifying the virtual vehicle may include rank information of the virtual vehicle and/or lap time information of the virtual vehicle.

According to various embodiments, the AVN device 241-2 may provide audible feedback that guides the vehicle 20 to follow a driving instruction. For example, the vehicle 20 may control the AVN device 241-2 to provide audible feedback for guiding adjustment of the vehicle speed to follow a driving instruction.

Referring to FIG. 14, the vehicle 20 may, based on images obtained from the plurality of cameras 251 being processed, obtain a bird's eye view. For example, the vehicle 20 may obtain a bird's eye view image of the vehicle 20 from a surround view monitor system included in the driver assistance device 250.

The vehicle 20 may control the AVN device 241-2 to display the bird's eye view image, and as described above, various types of information related to driving instructions may be mapped to and displayed on the bird's eye view image.

For example, the vehicle 20 may control the AVN device 241-2 such that a recommended trail line TL, a virtual vehicle image VI, circuit map information MI, a braking point BP, and apex information AP are mapped to and displayed on the bird's eye view image.

The images and information displayed on the head-up display 241-1 and the AVN device 241-2 are not limited to those described above, and may further include various types of information for assisting circuit driving. In addition, information that may be displayed on the head-up display 241-1 may also be displayed on the AVN device 241-2, and vice versa.

According to the present disclosure, a user may intuitively recognize and follow a driving instruction.

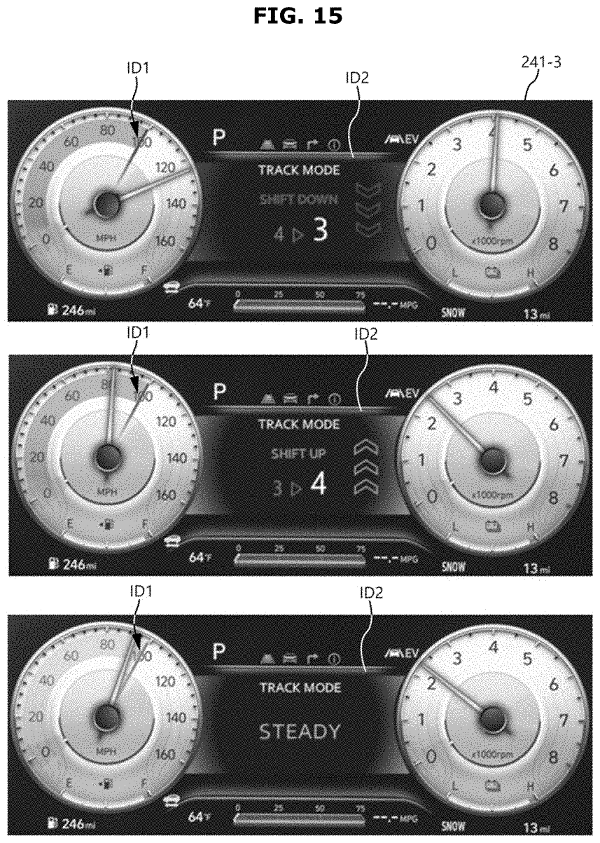

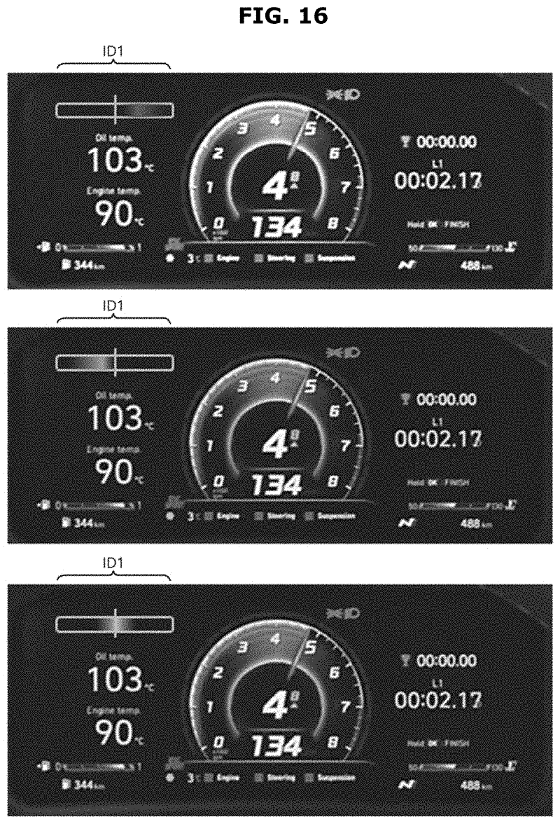

FIG. 15 illustrates an example of a vehicle providing a driving instruction through a cluster according to an embodiment. FIG. 16 illustrates another example of a vehicle providing a driving instruction through a cluster according to an embodiment.

Referring to FIGS. 15 and 16, the vehicle 20 may control the cluster 241-3 to provide visual feedback for following a driving instruction.

For example, the vehicle 20 may control the cluster 241-3 to display visual feedback ID1 for guiding adjustment of the vehicle speed to follow a driving instruction.

The visual feedback ID1 for guiding adjustment of a vehicle speed may be overlaid and displayed on a dashboard displayed in the cluster 241-3.

That is, the vehicle 20 may control the cluster 241-3 to display a dashboard indicating the vehicle speed, and control the cluster 241-3-to display visual feedback ID1 for guiding adjustment of the vehicle speed on the dashboard indicating the vehicle speed.

The visual feedback ID1 for guiding adjustment of the vehicle speed may be displayed in the form of a pointer indicating a recommended speed on the dashboard.

That is, the vehicle 20 may display the recommended speed according to the driving instruction on the dashboard using a virtual pointer.

As another example, the visual feedback ID1 for guiding adjustment of the vehicle speed may be displayed in the form of a gauge bar.

The visual feedback ID1 for guiding adjustment of the vehicle speed may change in color depending on whether the vehicle 20 requires deceleration, acceleration, or speed maintenance.

For example, the visual feedback ID1 for guiding adjustment of the vehicle speed when deceleration of the vehicle 20 is required may be displayed in red, and the visual feedback ID1 for guiding adjustment of the vehicle speed when acceleration of the vehicle 20 is required may be displayed in blue, and the visual feedback ID1 for guiding adjustment of the vehicle speed when the speed maintenance of the vehicle 20 is required may be displayed in yellow green, but the type of color is not limited thereto.

As another example, the vehicle 20 may control the cluster 241-3 to display visual feedback ID2 for guiding manipulation of a shift gear to follow a driving instruction.

The visual feedback ID2 for guiding the manipulation of the shift gear may be overlaid and displayed on the dashboard displayed in the cluster 241-3.

That is, the vehicle 20 may control the cluster 241-3 to display a dashboard indicating a shift gear level, and control the cluster 241-3 to display the visual feedback ID2 for guiding manipulation of the shift gear on the dashboard indicating the shift gear level.

The visual feedback ID2 for guiding the manipulation of the shift gear may change in color according to whether the shift gear of the vehicle 20 needs shift up, shifted down, or shift gear maintenance.

According to the present disclosure, a driving instruction related to information, for which the user needs to check the cluster 241-3, such as the vehicle speed and/or the level of the shift gear, may be displayed on the cluster 241-3, and a driving instruction related to information, which the user needs to check while looking forward, such as the recommended trail line TL, may be displayed on the head-up display 241-1 and/or the AVN device 241-2 so that intuitiveness of operating the vehicle is improved .

The embodiment described herein is not limited to an embodiment in which a user is provided with driving instructions while driving on a circuit.

For example, before driving on the circuit, a user may select one of the plurality of driving instructions and view a driving image related to the selected driving instruction.

That is, the vehicle 20 may provide a user with a driving image of a virtual vehicle that drives on the circuit by following a driving instruction selected by the user.

The driving image of the virtual vehicle refers to a video of the virtual vehicle driving on a circuit one round.

The driving image of the virtual vehicle may be processed in the form of a bird's eye view and/or a third person view and output through the user interface part 240.

Accordingly, the user may obtain driving tips in advance before driving on the circuit.

Although embodiments of the system 1 for assisting circuit driving and the method of assisting circuit driving have been shown and described above, the above embodiments are illustrative purpose only, and it would be appreciated by those skilled in the art that changes and modifications, which have not been illustrated above, may be made in these embodiments without departing from the principles and scope of the disclosure, the scope of which is defined in the claims and their equivalents.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, according to the disclosure, the method and system for assisting circuit driving can lower the entry barrier to the circuit driving for ordinary people.

According to the disclosure, the method and system for assisting circuit driving can provide users with interest to circuit driving.

According to the disclosure, the method and system for assisting circuit driving can allow users to identify and make up for the weakness of the users to improve the circuit driving skills.

According to the disclosure, the method and system for assisting circuit driving can allow users to imitate other people's circuit driving and supplement the circuit driving skills.

According to the disclosure, the method and system for assisting circuit driving can allow drivers to easily recognize a driving instruction during circuit driving.

What is claimed is:

1. A method of providing a driving instruction for assisting circuit driving, the method comprising:
constructing a database based on driving data obtained as a result of driving of a plurality of vehicles on a circuit;
generating a plurality of driving instructions based on the database; and
providing a user with at least one of the plurality of driving instructions based on a selection of the user.

2. The method of clam 1, wherein the plurality of driving instructions include at least one selected from a recommended speed for each section of the circuit, a recommended braking point of the circuit, a recommended acceleration point of the circuit, a recommended shift section of the circuit, a recommended steering amount for each section of the circuit, an APEX of the circuit, a recommended trail line of the circuit, and combinations thereof.

3. The method of claim 1, wherein the providing of the user with the at least one of the plurality of driving instructions includes:
transmitting a first driving instruction selected by the user to a first vehicle of the user; and
displaying, by the first vehicle, the first driving instruction on at least one selected from a head-up display, an audio-video-navigation (AVN) device, a cluster, and combinations thereof.

4. The method of claim 3, wherein the displaying, by the first vehicle, of the first driving instruction includes
displaying visual feedback for following the first driving instruction based on driving data of the first vehicle.

5. The method of claim 3, wherein the displaying, by the first vehicle, of the first driving instruction includes
controlling the head-up display such that a recommended trail line included in the first driving instruction is mapped to a road of the circuit.

6. The method of claim 3, wherein the displaying, by the first vehicle, of the first driving instruction includes:
generating a virtual vehicle image based on the first driving instruction; and
controlling the head-up display such that the virtual vehicle image is mapped to a road of the circuit.

7. The method of claim 3, wherein the displaying, by the first vehicle, of the first driving instruction includes:
displaying, on the AVN device, a road image of the circuit obtained from a front camera; and
controlling the AVN device such that a recommended trail line included in the first driving instruction is mapped to the road image of the circuit.

8. The method of claim 3, wherein the displaying, by the first vehicle, of the first driving instruction includes:
displaying, on the AVN device, a road image of the circuit obtained from a front camera;
generating a virtual vehicle image based on the first driving instruction; and
controlling the AVN device such that the virtual vehicle image is mapped to the road image of the circuit.

9. The method of claim 3, wherein the displaying, by the first vehicle, of the first driving instruction includes
controlling the cluster to display visual feedback for guiding adjustment of a vehicle speed to follow the first drive instruction.

10. The method of claim 3, wherein the displaying, by the first vehicle, of the first driving instruction includes
controlling the cluster to display visual feedback for guiding manipulation of a shift gear to follow the first drive instruction.

11. The method of claim 1, wherein the plurality of driving instructions include a first driving instruction and a second driving instruction, and
the method further comprises:
outputting visual feedback indicating that the first driving instruction is a driving instruction for a beginner; and
outputting visual feedback indicating that the second driving instruction is a driving instruction for an intermediate or advanced user.

12. The method of claim 1, wherein the generating of the plurality of driving instructions based on the database includes:
generating a first driving instruction based on first driving database obtained from a first vehicle; and
generating a second driving instruction based on second driving database obtained from a second vehicle.

13. The method of claim 1, wherein the generating of the plurality of driving instructions based on the database includes:
obtaining first driving data for minimizing a driving record by inputting the driving data for constructing the database into a trained neural network model; and
generating a first driving instruction based on the first driving data.

14. The method of claim 1, wherein the providing of the user with one of the plurality of driving instructions includes
providing the user with a driving image of a virtual vehicle driving on the circuit according to the driving instruction selected by the user.

15. A system for providing a driving instruction for assisting circuit driving, the system comprising:
a server configured to store a database constructed based on driving data obtained as a result of driving of a plurality of vehicles on a circuit, and generate a plurality of driving instructions based on the database; and
a first vehicle configured to, based on receiving a user input to select a first driving instruction among the plurality of driving instructions, transmit a request signal for requesting the server to transmit the first driving instruction,
wherein the server is configured to, based on receiving the request signal from the first vehicle, transmit the first driving instruction to the first vehicle, and
the first vehicle is configured to, based on receiving the first driving instruction, display the first driving instruction on at least one selected from a head-up display, an audio-video-navigation (AVN) device, a cluster, and combinations thereof.

16. The system of claim 15, wherein the first vehicle is configured to display visual feedback for following the first driving instruction based on driving data of the first vehicle.

17. The system of claim 15, wherein the first vehicle is configured to control the head-up display such that a recommended trail line included in the first driving instruction is mapped to a road of the circuit.

18. The system of claim 15, wherein the first vehicle is configured to:
generate a virtual vehicle image based on the first driving instruction; and
control the head-up display such that the virtual vehicle image is mapped to a road of the circuit.

19. The system of claim 15, wherein the first vehicle is configured to:
display, on the AVN device, a road image of the circuit obtained from a front camera; and
control the AVN device such that a recommended trail line included in the first driving instruction is mapped to the road image of the circuit.

20. The system of claim 15, wherein the first vehicle is configured to:
display, on the AVN device, a road image of the circuit obtained from a front camera;
generate a virtual vehicle image based on the first driving instruction; and
control the AVN device such that the virtual vehicle image is mapped to the road image of the circuit.
